(19) United States
(12) Patent Application Publication
(10) Pub. No.: US 2025/0279419 A1
(43) Pub. Date: Sep. 4, 2025

(54) LITHIUM METAL NEGATIVE ELECTRODE, ELECTROLYTE ADDITIVE FOR LITHIUM SECONDARY BATTERY AND ELECTROLYTE INCLUDING THE SAME

(71) Applicants: Hyundai Motor Company, Seoul (KR); Kia Corporation, Seoul (KR); SEOUL NATIONAL UNIVERSITY R&DB FOUNDATION, Seoul (KR)

(72) Inventors: Jongchan Song, Hwaseong (KR); WonKeun Kim, Hwaseong (KR); Areum Ha, Hwaseong (KR); JaeWook Shin, Hwaseong (KR); SeungJong Lee, Hwaseong (KR); Kyoung Han Yew, &Hwaseong (KR); Seongmin Ha, Hwaseong (KR); Kyu Tae Lee, Seoul (KR); Kyobin Park, Seoul (KR)

(21) Appl. No.: 19/069,945

(22) Filed: Mar. 4, 2025

(30) Foreign Application Priority Data
Mar. 4, 2024 (KR) 10-2024-0030652

(51) Int. Cl. H01M 4/38; H01M 4/02; H01M 4/134; H01M 4/36; H01M 10/0567; H01M 10/0568; H01M 10/0569

(52) U.S. Cl. CPC H01M 4/382; H01M 4/134; H01M 4/366; H01M 10/0567; H01M 10/0568; H01M 10/0569; H01M 2004/027

(57) ABSTRACT

A lithium metal negative electrode incorporates a solid-electrolyte interphase (SEI) with distinct inorganic and organic layers, alongside an electrolyte containing a specialized additive. The inorganic layer, close to the lithium metal, may contain Li—F and Si—F bonds, while the organic layer may include carbon- and oxygen-containing CxOy or Si—C. The additive is defined by formulas involving a metal positive ion, Si, and trimethylsilyl groups, and may enhance cycling stability by forming a uniform SEI that suppresses lithium dendrite formation. When combined with an ether-based solvent, the additive can be present in amounts from about 0.1 to about 50 parts by weight of the electrolyte. The resulting battery exhibits high coulombic efficiency, reduced overvoltage, and retains at least 80% of its initial capacity after 100 charge-discharge cycles at a rate of 1C or higher, thus offering improved performance and longevity for lithium secondary battery applications.

### CROSS-REFERENCE TO RELATED APPLICATION

This application claims under 35 U.S.C. § 119(a) the benefit of Korean Patent Application No. 10-2024-0030652 filed in the Korean Intellectual Property Office on Mar. 4, 2024, the entire contents of which are incorporated herein by reference.

### BACKGROUND

### Technical Field

The present disclosure relates to a lithium metal negative electrode, an electrolyte additive for a lithium rechargeable battery, and an electrolyte including the same.

### Background

A battery is an energy storage device that can convert chemical energy into electrical energy or electrical energy into chemical energy. Batteries can be divided into primary batteries, which cannot be reused, and rechargeable batteries, which can be reused. Rechargeable batteries have the advantage of being environmentally friendly compared to primary batteries, which are used once and then thrown away, because they can be reused.

As environmental issues have recently become a topic of discussion, demand for HEVs (Hybrid Electric Vehicles) and EVs (Electric Vehicles) that produce little or no air pollution is increasing. In particular, an EV is a vehicle with the internal combustion engine completely removed, suggesting the direction the world should pursue in the future.

A lithium rechargeable battery is used as the energy source for EVs. A lithium rechargeable battery is largely composed of a positive electrode, negative electrode, electrolyte, and separator. At the positive and negative electrodes, energy is generated through repeated intercalation and deintercalation of lithium ions, the electrolyte acts as a passage through which lithium ions move, and the separator prevents a short circuit from occurring within the battery when the positive and negative electrodes meet.

The positive electrode is closely related to the capacity of the battery, while the negative electrode is closely related to the performance of the battery, such as high-speed charging and discharging.

The electrolyte consists of solvent, additive, and lithium salt. The solvent serves as a migration passage that helps lithium ions move between the positive and negative electrodes. For a battery to perform well, lithium ions must be transferred quickly between the positive and negative electrodes. Therefore, selecting the optimal electrolyte is a very important issue to obtain excellent battery performance.

Meanwhile, since lithium metal has an excellent theoretical capacity of 3,860 mAh/g and a very low Standard Hydrogen Electrode (SHE) potential of −3.045 V, it enables the development of high-capacity, high-energy density batteries. Accordingly, much research is being conducted on lithium metal batteries (LMB) that use lithium metal as the negative electrode active material of lithium rechargeable batteries.

However, lithium metal batteries have a problem in that lithium metal easily reacts with electrolytes, impurities, lithium salts, etc. due to its high chemical/electrochemical reactivity, forming a passive layer (Solid Electrolyte Interphase; SEI) on the electrode surface, and this passive layer causes a difference in local current density, forming dendrites on the lithium metal surface.

These lithium dendrites not only shorten the life-span of lithium rechargeable batteries, but they also cause internal short circuits and dead lithium, which aggravates the physical and chemical instability of lithium rechargeable batteries, reduces battery capacity, shortens the life-span, and negatively affects overall battery stability.

In addition, the passive layer is thermally unstable and can gradually collapse due to increased electrochemical energy and thermal energy when the battery is continuously charged and discharged, or particularly when stored at high temperatures in a fully charged state. Due to the collapse of this passive layer, the exposed lithium metal surface continuously decomposes through direct reaction with the electrolyte solvent, which increases the resistance of the negative electrode and deteriorates the charging and discharging efficiency of the battery.

In particular, conventional electrolytes form an SEI layer on the lithium metal surface due to solvents, which causes some problems in deteriorating the stability of the lithium metal layer and the reversibility of the lithium metal.

Therefore, in lithium metal batteries that use lithium metal as a negative electrode, there is a need to develop an electrolyte and negative electrode structure that can suppress performance degradation while stabilizing the interface of the lithium metal, which is the negative electrode.

### SUMMARY OF THE DISCLOSURE

The present disclosure aims to provide a lithium metal negative electrode with improved stability at high current densities.

In addition, the present disclosure aims to provide an electrolyte additive and an electrolyte containing the same which can improve stability at high current density and increase the reversibility of lithium metal to provide high coulomb efficiency.

The present disclosure provides a lithium metal negative electrode, comprising: a lithium metal layer positioned on a current collector surface; and an SEI layer positioned on a surface of the lithium metal layer, wherein the SEI layer includes an inorganic layer and an organic layer.

Additionally, the present disclosure provides an electrolyte additive represented by the following formula 1.

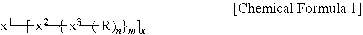

In formula 1 above,
X¹ is a metal positive ion,
each X² is independently N, P or B,
X³ is independently Si,
each R is an independently substituted or unsubstituted alkyl group of C1 to C6,
n is an integer from 1 to 3,
m is an integer from 1 to 3,
x is an integer from 1 to 3,
However, at least 3 of —X³—R are trimethylsilyl.

Additionally, the present disclosure provides an electrolyte comprising an electrolyte additive represented by the following formula 1 and an ether electrolyte.

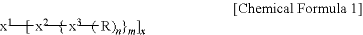

In formula 1 above,
X¹ is a metal positive ion,
each X² is independently N, P or B,
X³ is independently Si,
each R is an independently substituted or unsubstituted alkyl group of C1 to C6,
n is an integer from 1 to 3,
m is an integer from 1 to 3,
x is an integer from 1 to 3,

However, at least 3 of —X³—R are trimethylsilyl.

In some embodiments, a lithium secondary battery comprises a positive electrode including a positive electrode active material; a negative electrode including a current collector and a lithium metal layer positioned on the current collector surface, the lithium metal layer having, on its surface, a solid-electrolyte interphase (SEI) layer that comprises an inorganic layer and an organic layer, wherein the inorganic layer is positioned closer to the lithium metal layer than the organic layer, and wherein the inorganic layer comprises at least one compound having a Li—F bond and a Si—F bond; a separator interposed between the positive electrode and the negative electrode; and an electrolyte comprising an electrolyte additive represented by the following Formula 1:

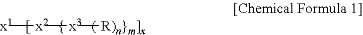

In Formula 1, X1 is a metal positive ion,
each X2 is independently N, P or B,
X3 is independently Si,
each R is an independently substituted or unsubstituted alkyl group of C1 to C6,
n is an integer from 1 to 3,
m is an integer from 1 to 3,
x is an integer from 1 to 3,
however, at least 3 of —X3—R are trimethylsilyl.

The organic layer of the SEI may comprise a carbon- and oxygen-containing structure denoted CxOy, and the inorganic layer and organic layer together may form a layered SEI that improves uniformity of local current density at the lithium metal surface during charge-discharge cycling.

The organic layer of the SEI may comprise Si—C generated from the electrolyte additive.

The electrolyte additive may be represented by the following Formula 2:

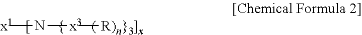

In Chemical Formula 2, X1, X3, n, and x are defined as in Formula 1 above.

The electrolyte may further comprise an ether-based solvent mixture including one or more selected from the group consisting of acyclic ethers and cyclic ethers, and the electrolyte additive may be present in an amount of about 0.1 to about 50 parts by weight per 100 parts by weight of the electrolyte.

The electrolyte may comprise LiFSI as a lithium salt in a concentration of about 0.5 M to about 4.0 M, the electrolyte additive may be Tris[N,N-bis(trimethylsilyl)amide]lanthanum(III), and the lithium metal negative electrode may exhibit high coulombic efficiency and reduced overvoltage at current densities above 1 mA/cm\hat{ }2.

The SEI may be adapted to reduce formation of lithium dendrites and maintain reversible capacity after repeated cycling, such that the battery retains at least 80% of its initial discharge capacity after 100 charge-discharge cycles at a rate of 1C or higher.

The lithium metal negative electrode according to the present disclosure has the advantage of uniform local current density and excellent stability even at high current density because it includes an SEI layer including an inorganic layer and an organic layer.

In addition, the electrolyte additive and electrolyte according to the present disclosure have the advantage of improving stability at high current density and increasing the reversibility of lithium metal to provide high coulomb efficiency.

As discussed, the method and system suitably include use of a controller or processer.

In other embodiments, vehicles are provided that comprise an apparatus as disclosed herein.

### BRIEF DESCRIPTION OF THE DRAWINGS

FIG. 1 is a schematic image of the SEI layer of a lithium metal negative electrode according to some embodiments of the present disclosure.

FIG. 2 is a schematic image of the SEI layer of a conventional lithium metal negative electrode.

FIGS. 3 to 5 are diagrams showing the kinetic changes in electrodeposition of lithium metal according to an embodiment and a comparative example.

FIGS. 6 to 8 are diagrams showing the results of in-situ EIS measurement while sequentially depositing lithium metal according to an embodiment and a comparative example.

FIGS. 9 to 11 are diagrams showing the results of structure analysis of the SEI layer of a lithium rechargeable battery according to an embodiment and a comparative example.

FIG. 12 is a diagram showing the result of clarifying the order of decomposition products according to an embodiment and a comparative example.

FIGS. 13 to 16 are diagrams showing the results of observing the morphology of cycled lithium and electrodeposited lithium according to an embodiment and a comparative example.

FIG. 17 is a diagram showing the results of measuring Voltage/V vs. Li/Li⁺ according to the cycle of an embodiment and a comparative example.

FIG. 18 is a diagram showing the results of measuring coulomb efficiency according to the cycle of an embodiment and a comparative example.

FIGS. 19 to 21 are diagrams showing the results of measuring Voltage/V vs. Li/Li⁺ according to the time for an embodiment and a comparative example.

FIGS. 22 to 24 are diagrams showing the specific capacity and discharge capacity results according to the cycle of an embodiment and a comparative example.

FIG. 25 is a diagram showing the results of measuring intensity according to binding energy of an embodiment and a comparative example.

FIG. 26 is a diagram showing the result of structure analysis of the SEI layer of a lithium rechargeable battery according to an embodiment.

FIG. 27 is a diagram showing the results of measuring coulomb efficiency according to cycles of an embodiment and a comparative example.

FIG. 28 is a diagram showing the results of measuring Voltage/V vs. Li/Li⁺ according to the time for an embodiment and a comparative example.

### DETAILED DESCRIPTION OF THE EMBODIMENTS

Below, an implementation example of the present disclosure will be described in detail. However, this is provided as an example and the present disclosure is not limited thereby, and the present disclosure is only defined by the scope of the claims described below.

When it is said that a member in the present disclosure is positioned “on” another member, this includes not only cases where a member is directly in contact with another member, but also cases where another member is interposed between the two members.

When it is said that a part of the present disclosure “comprise, include, contain, or have” a component, this does not mean that it excludes other components, but rather that it may include other components, unless otherwise specifically stated.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

The term “NMP” herein refers to N-methyl-2-pyrrolidone, which is commonly used as a solvent in preparing electrode slurries for lithium rechargeable batteries.

The term “PVDF” herein refers to polyvinylidene fluoride, which is often employed as a binder to hold electrode materials together.

The term “EC” herein refers to ethylene carbonate, a widely used solvent component in lithium battery electrolytes.

The term “EMC” herein refers to ethyl methyl carbonate, another common solvent component for lithium battery electrolytes.

The term “DME” herein refers to 1,2-dimethoxyethane, an ether-type solvent known for enhancing ion transport in certain electrolyte formulations.

The term “TFOFE” herein refers to 1H,1H,5H-octafluoropentyl 1,1,2,2-tetrafluoroethyl ether, a partially fluorinated ether solvent that can improve electrolyte stability.

The term “TTE” herein refers to 1,1,2,2-tetrafluoroethyl 2,2,3,3-tetrafluoropropyl ether (or another tetrafluoroalkyl ether, if applicable), used in advanced high-energy-density battery electrolytes.

The term “CV” (Cyclic Voltammetry) herein refers to an electrochemical technique where the potential of the electrode is swept linearly over time to measure current responses, used for studying redox processes and SEI formation.

The term “EIS” (Electrochemical Impedance Spectroscopy) herein refers to a technique that measures the impedance of a cell over a range of frequencies, helping to characterize charge transfer and other kinetic phenomena in the battery.

The term “SEM” (Scanning Electron Microscopy) herein refers to a method for producing high-resolution images of a sample's surface morphology, useful for observing the SEI layer.

The term “ToF-SIMS” (Time-of-Flight Secondary Ion Mass Spectrometry) herein refers to a surface analytical technique that identifies elemental and molecular species in the outermost layers of a sample by measuring ejected ions over time.

The term “C-rate” herein refers to the rate at which a battery is charged or discharged relative to its nominal capacity (e.g., 1C means the battery is charged or discharged at a rate that would fully charge or discharge it in one hour).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

### Lithium Metal Negative Electrode

One aspect of the present disclosure relates to a lithium metal negative electrode, comprising: a lithium metal layer positioned on a current collector surface; and an SEI layer positioned on a surface of the lithium metal layer, wherein the SEI layer includes an inorganic layer and an organic layer.

The lithium metal negative electrode according to the present disclosure has excellent reversibility and reduction stability of lithium metal because it includes a multilayer SEI layer including an inorganic layer and an organic layer and has excellent electrochemical characteristics when applied to a lithium rechargeable battery.

The current collector is for electrical connection within the battery and may have the form of a thin film (foil) but is not limited thereto.

For example, the current collector may be in the form of a thin plate (sheet) made by weaving mesh, foam, rod, wire, or wire (fiber), but is not limited thereto.

The current collector can be made of a material that has electrical conductivity and has limited reaction with lithium.

For example, the current collector can be made of copper, nickel, titanium, stainless steel, gold, platinum, silver, tantalum, ruthenium, alloys thereof, carbon, conductive polymer, composite fiber with a conductive layer coated on a non-conductive polymer, etc.

Preferably, the material of the current collector can be copper.

The lithium metal layer may include lithium metal or lithium metal alloy.

The lithium metal alloy may contain an alloy of lithium and a metal or metalloid that can be alloyed with lithium.

The metal or metalloid that can be alloyed with lithium may include, but is not limited to, Si, Sn, Al, Ge, Pb, Bi, Sb, etc.

The SEI layer can be referred to as a solid electrolyte interphase (SEI) layer formed by the reaction between the metal in the lithium metal layer and the electrolyte containing the electrolyte additive represented by Chemical Formula 1 described below.

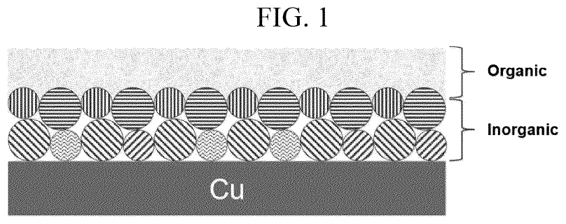

The SEI layer according to the present disclosure includes an inorganic layer and an organic layer. FIG. 1 illustrates the shape of the SEI layer according to some embodiments of the present disclosure.

Although we do not wish to be limited by theory, it is generally accepted that the SEI layer is a mixture of inorganic and organic materials.

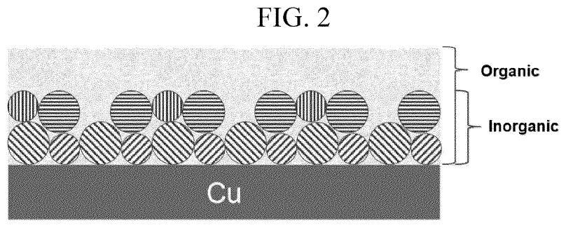

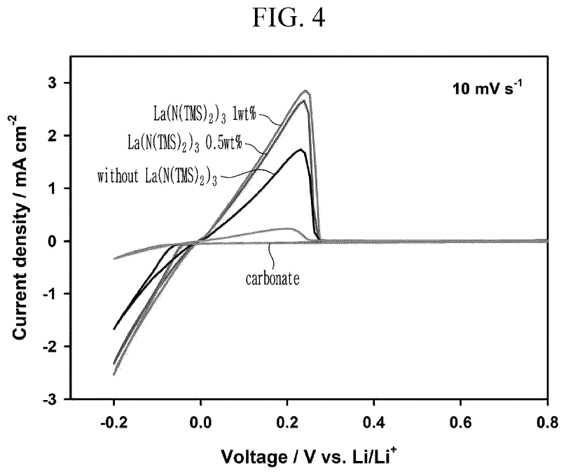

However, according to the present disclosure, the SEI layer is formed by first reducing La(N(TMS)₂)₃) to form the SEI layer, so the Si-based inorganic SEI and the anion-based inorganic SEI of FSI form the inner SEI layer. Since the SEI layer due to solvent decomposition forms an outer SEI layer, the inorganic layer and the organic layer are formed in the form of a layered structure (see FIG. 4D). Accordingly, it has the advantage of uniform local current density and excellent stability even at high current density. Specifically, the red particles in FIGS. 1 and 2 represent SEI components resulting from negative ion decomposition, the blue particles represent SEI components resulting from solvent decomposition, and the green particles represent SEI components resulting from additive decomposition such as Si—F.

In some embodiments of the present disclosure, the inorganic layer can be positioned closer to the lithium metal layer than the organic layer.

Specifically, the inorganic layer can be prepared closer to the lithium metal layer than the organic layer because it is inorganic richer and undergoes reduction decomposition first. More specifically, the lithium metal negative electrode according to the present disclosure may include a current collector, a lithium metal layer provided on the current collector, an inorganic layer provided on the lithium metal layer, and an organic layer provided on the inorganic layer.

Since the inorganic layer is arranged closer to the lithium metal layer than the organic layer, it is preferable to form a uniform lithium-ion flux.

In other embodiments of the present disclosure, the inorganic layer may comprise one or more selected from the group consisting of Li—F and Si—F. Specifically, the inorganic layer may include one or more compounds selected from the group consisting of a compound having a Li—F bond and a compound having a Si—F bond.

Compounds having a Li—F bond and a Si—F bond are preferable because they can effectively suppress electron tunneling due to their wide bandgap and can effectively suppress the irreversible reaction of lithium metal during repeated cycling due to their rigid characteristics.

In other embodiments of the present disclosure, the organic layer may comprise CₓO_{y}. the CₓO_{y} can include for example, C—O, C═O, etc.

The organic layer may further comprise Si-C generated from an additive.

When the organic layer contains CₓO_{y}, flexibility can be imparted.

In other embodiments of the present disclosure, a compound having Si—F bonds within the SEI layer may be present.

Specifically, the compound having the Si—F bond can exist within the inorganic layer and can be the first to decompose, thereby helping to form the inner inorganic SEI layer. This can form a SEI double layer to provide a uniform lithium-ion flux and improve the high-rate characteristics as a result.

### Electrolyte Additive

Another aspect of the present disclosure relates to an electrolyte additive represented by the following formula 1.

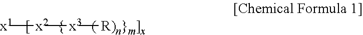

In formula 1 above,
X¹ is a metal positive ion,
each X² is independently N, P or B,
X³ is independently Si,
each R is an independently substituted or unsubstituted alkyl group of C1 to C6,
n is an integer from 1 to 3,
m is an integer from 1 to 3,
x is an integer from 1 to 3,
However, at least 3 of —X³—R are trimethylsilyl.

The metal cation can be one or more selected from the group consisting of La, Li, Nd, Sm and Gd.

In other embodiments of the present disclosure, the X¹ can be La.

When the metal positive ion is La, the effect of improving the reversibility of lithium metal is maximized, which is preferable.

In the present disclosure, the “alkyl group” may be linear or branched, and may be, for example, but not limited to, methyl, ethyl, n-propyl, isopropyl, n-butyl, isobutyl, tert-butyl, sec-butyl, 1-methyl-butyl, 1-ethyl-butyl, n-pentyl, isopentyl, neopentyl, tert-pentyl, n-hexyl, 1-methylpentyl, 2-methylpentyl or 4-methyl-2-pentyl.

In the present disclosure, the substituent in substituted or unsubstituted may be, but is not limited to, a halogen group, a nitrile group, a nitro group, an amino group, or an alkyl group having 1 to 6 carbon atoms.

In other embodiments of the present disclosure, the X² can be N.

In other embodiments of the present disclosure, the electrolyte additive represented by the above formula 1 can be represented by the following formula 2.

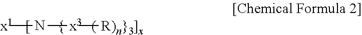

In Chemical Formula 2,
X¹, X³, n and x are defined as in formula 1 above.

In other embodiments of the present disclosure, in the above formula 2, X³ can be Si, and R can be a methyl group.

In other embodiments of the present disclosure, X¹ in the above formula 2 can be La.

In other embodiments of the present disclosure, the above formula 2 can be represented as the following formula 3.

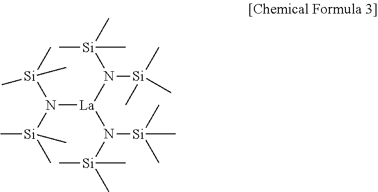

In short, the electrolyte additive for lithium rechargeable battery according to the present disclosure can be represented by Chemical Formula 3. When the electrolyte additive for a lithium rechargeable battery according to the present disclosure is represented by the above formula 3, it is preferable to form an SEI layer having a layered structure of an inorganic layer and an organic layer.

Specifically, the electrolyte additive for a lithium rechargeable battery according to the present disclosure may be La(N(TMS)₂)₃ (Tris[N-N-bis(trimethylsilyl)amide]lanthanum(III)).

Although not wishing to be limited by the theory, the electrolyte additive for lithium rechargeable batteries according to the present disclosure decomposes before the anion, and since the decomposition product is an inorganic component originating from Si—F, it can form an inorganic layer.

The electrolyte additive for lithium rechargeable batteries according to the present disclosure can improve the high-rate characteristics and coulomb efficiency in LHCE (localized high concentration electrolyte)-based lithium metal batteries by modifying the SEI of lithium metal, and also has the advantage of improving the life-span characteristics of NCM/Li cells.

In addition, it has the effect of scavenging ether radicals, so it can improve oxidative stability, and it can also improve the uniformity of lithium during electrodeposition, thereby improving the morphology of the SEI layer to be smooth, and it has the effect of reducing sheet resistance.

### Electrolyte for Lithium Rechargeable Battery

Another aspect of the present disclosure relates to an electrolyte comprising an electrolyte additive represented by the following formula 1 and an ether electrolyte.

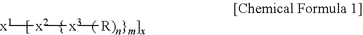

In formula 1 above,
X¹ is a metal positive ion,
each X² is independently N, P or B,
X³ is independently Si,
each R is an independently substituted or unsubstituted alkyl group of C1 to C6,
n is an integer from 1 to 3,
m is an integer from 1 to 3,
x is an integer from 1 to 3,
However, at least 3 of —X³—R are trimethylsilyl.

The contents of the above formula 1 can be applied to the aforementioned contents.

In other embodiments of the present disclosure, the electrolyte additive may be included in an amount of 0.1 to 50 parts by weight relative to the entire 100 parts by weight of the electrolyte.

Preferably the electrolyte additive can be included in amounts of 0.1 to 30 parts by weight, more preferably 0.5 to 10 parts by weight.

When the electrolyte additive is included in the range, it is preferable that the solubility of the electrolyte additive is excellent, the reversibility of lithium metal is increased, and an SEI layer with low surface roughness can be formed. In addition, it is preferable that the phenomenon of increasing the viscosity of the electrolyte is suppressed.

Since the ether electrolyte has a large donor number, it can effectively dissolve the electrolyte additive represented by Chemical Formula 1 according to the present disclosure, forms an inorganic SEI layer, and exhibits the effect of suppressing the decomposition of the ether electrolyte forming an organic SEI layer.

In other embodiments of the present disclosure, the ether electrolyte may be included as a remainder to the electrolyte entire 100 parts by weight. Specifically, the ether electrolyte may be included in amounts of 50 to 99.9 parts by weight relative to the entire 100 parts by weight of the electrolyte. It can be included preferably in 70 to 99.9 parts by weight, more preferably in 90 to 99.5 parts by weight.

If the ether system is included in the range, it is preferable to increase the solubility of the electrolyte additive and to allow the electrolyte to have an appropriate viscosity.

In other embodiments of the present disclosure, the ether electrolyte may comprise one or more selected from the group consisting of a non-cyclic ether and a cyclic ether.

The non-cyclic ether is for example, 1,2-dimethoxyethane, 1,2-diethoxyethane, 1,2-dibutoxyethane, dimethyl ether, diethyl ether, dibutylether, diethylene glycol dimethyl ether, diethylene glycol diethyl ether, triethylene glycol dimethyl ether, triethylene glycol diethyl ether, tetraethylene glycol dimethyl ether, tetraethylene glycol diethyl ether, dimethyl sulfoxide, hydrofluoro ether and N,N-dimethyl acetamide can be selected from among, but is not limited to, a linear or branched organic compound containing an ether group can be appropriately selected.

The cyclic eters are, for example, 1,3-dioxolane, 4,5-dimethyl-dioxolane, 4,5-diethyl-dioxolane, 4-methyl-1,3-dioxolane, 4-ethyl-1,3-dioxolane, tetrahydrofuran, 2-methyl tetrahydrofuran, 2,5-dimethyl tetrahydrofuran, 2,5-dimethoxy tetrahydrofuran, 2-ethoxy tetrahydrofuran, 2-methyl-1,3-dioxolane, 2-vinyl-1,3-dioxolane, 2,2-dimethyl-1,3-dioxolane, 2-methoxy-1,3-dioxolane, 2-ethyl-2-methyl-1,3-dioxolane, tetrahydropyran, 1,4-dioxane, 1,2-dimethoxy benzene, 1,3-dimethoxy benzene, 1,4-dimethoxy benzene, isosorbide dimethyl ether, 1H,1H,5H-Octafluoropentyl 1,1,2,2-Tetrafluoroethyl Ether, bis(2,2, 2-trifluoroethyl) ether, 1,1,2,2-tetrafluoroethyl ether, 1,1,2,2-tetrafluoroethyl 2,2,3,3-tetrafluoropropyl ether and tris(2,2,2-trifluoroethyl) phosphate but is not limited thereto, and a cyclic organic compound including an ether group can be appropriately selected.

Specifically, the ether-based electrolyte according to the present disclosure is one or more selected from the a group consisting of dimethyl ether, 1H,1H,5H-Octafluoropentyl 1,1,2,2-Tetrafluoroethyl Ether, bis(2,2, 2-trifluoroethyl) ether, 1,1,2,2-tetrafluoroethyl ether, 1,1,2,2-tetrafluoroethyl 2,2,3,3-tetrafluoropropyl ether and tris(2,2,2-trifluoroethyl) phosphate and hydrofluoro ether.

More specifically, the ether electrolyte can be a mixture of dimethyl ether and hydrofluoro ether.

When the ether electrolyte is a mixture of the dimethyl ether and the hydrofluoro ether, it is preferable to minimize the charge transfer resistance.

The dimethyl ether and the hydrofluoro ether can be included in a weight ratio of 30:70 to 70:30, preferably 40:60 to 60:40.

The electrolyte may further include one or more lithium salts selected from the group consisting of LiFSI, LiNO₃, LITFSI, LiDFBP, and LiPO₂F₂.

Preferably the electrolyte can further contain excellent LiFSI solubility in the ether solvent.

The lithium salt may have a concentration of 0.5 to 4.0 M, preferably 1.0 to 4.0 M, more preferably 2.0 to 4.0 M.

When the concentration of the lithium salt satisfies the range, the electrolyte conductivity is high, so the electrolyte performance is excellent, and the viscosity of the electrolyte is appropriate, so the mobility of lithium ions is reduced and the problem of overvoltage from the beginning can be suppressed.

An electrolyte containing an electrolyte additive and an ether electrolyte represented by Chemical Formula 1 according to the present disclosure can be usefully used as an electrolyte for a lithium rechargeable battery.

Specifically, the electrolyte including the electrolyte additive represented by the formula 1 above and the ether electrolyte can form an ordered crystalline/amorphous SEI, specifically, an SEI layer including an inorganic layer and an organic layer, thereby uniformizing the local current density.

The lithium rechargeable battery includes a positive electrode including a positive electrode active material, a lithium metal layer positioned on a current collector surface; and an SEI layer positioned on a surface of the lithium metal layer, wherein the SEI layer includes a lithium metal negative electrode including an inorganic layer and an organic layer, and a separator interposed between the positive electrode and the negative electrode, and an electrolyte including an electrolyte additive represented by Chemical Formula 1 and an ether-based electrolyte.

At this time, the lithium rechargeable battery can be manufactured according to a conventional method known in the art. For example, a positive electrode, a negative electrode, and a separator between the positive and negative electrodes are sequentially laminated to form an electrode assembly, and then the electrode assembly is inserted into a battery case and an electrolyte according to the present disclosure is injected to manufacture the battery, whereby an SEI layer including an inorganic layer and an organic layer can be formed on the surface of the lithium metal negative electrode.

The following examples illustrate the present disclosure in more detail. However, the following embodiment is only a preferable embodiment and the present disclosure is not limited to the following embodiment.

### Examples and Comparative Examples

The electrolytes used in the embodiment, comparative example, and experimental example are as shown in the following Table 1. At this time, the electrolyte additive in the following Table 1 was added to satisfy each content for the entire 100 parts by weight of the electrolyte.

TABLE 1

| Division | Compound | Composition |
|---|---|---|
| Comparative Example 1 | Conventional | 1M LiPF6 in EC/EMC (3/7, v/v) |
| Comparative Example 2 | LHCE | 2.5M LiFSI in DME/TFOFE (8/2, |
| | | v/v)(TFOFE: 1H,1H,5H- |
| | | Octafluoropentyl 1,1,2,2- |
| | | Tetrafluoroethyl Ether) |
| Comparative Example 3 | Carbonate | 1M LiPF6 in EC/EMC (3/7, v/v) |
| Comparative Example 4 | Without La(N(TMS)₂)₃ | 2.5M LiFSI in DME/TFOFE (8/2, |
| | | v/v) |
| embodiment 1 | La(N(TMS)₂)₃ 0.5 wt % | 2.5M LiFSI in DME/TFOFE (8/2, |
| | | v/v) + La(N(TMS)₂)₃ 0.5 wt % |
| embodiment 2 | La(N(TMS)₂)₃ 1 wt % | 2.5M LiFSI in DME/TFOFE (8/2, |
| | | v/v) + La(N(TMS)₂)₃ 1 wt % |
| embodiment 3 | Gd(N(TMS)₂)₃ 0.5 wt % | 2.5M LiFSI in DME/TFOFE (8/2, |
| | | v/v) + Gd(N(TMS)₂)₃ 0.5 wt % |
| embodiment 4 | Gd(N(TMS)₂)₃ 1 wt % | 2.5M LiFSI in DME/TFOFE (8/2, |
| | | v/v) + Gd(N(TMS)₂)₃ 1 wt % |
| embodiment 5 | Li(N(TMS)₂) 0.5 wt % | 2.5M LiFSI in DME/TFOFE (8/2, |
| | | v/v) + Li(N(TMS)₂) 0.5 wt % |
| embodiment 6 | Li(N(TMS)₂) 1 wt % | 2.5M LiFSI in DME/TFOFE (8/2, |
| | | v/v) + Li(N(TMS)₂) 1 wt % |
| Comparative Example 5 | 1.5M LiFSI DME/TTE | 1.5M LiFSI DME/TTE (1/1, v/v) |
| embodiment 7 | 1.5M LiFSI DME/TTE + | 1.5M LiFSI DME/TTE (1/1, |
| | LIHMDS 1 wt % | v/v) + LiHMDS 1 wt % |
| | | (LiHMDS: Lithium |
| | | bis(trimethylsilyl)amide) |
| embodiment 8 | 1.5M LiFSI DME/TTE + | 1.5M LiFSI DME/TTE (1/1, v/v) + |
| | La(N(TMS)₂)₃ 1 wt % | La(N(TMS)₂)₃ 1 wt % |
| embodiment 9 | 1.5M LiFSI DME/TTE + | 1.5M LiFSI DME/TTE (1/1, v/v) + |
| | Gd(N(TMS)₂)₃ 1 wt % | Gd(N(TMS)₂)₃ 1 wt % |

### Experimental Examples

### (1) Lithium Rechargeable Battery Manufacturing

Positive electrode slurry was prepared by adding positive electrode active material (LiNi_{0.8}Co_{0.1}Mn_{0.1}O₂):conductive material (carbon nanotube):binder (polyvinylidenefluoride) to NMP (solvent) at a weight ratio of 8:1:1. The positive electrode slurry was applied to one side of the positive electrode current collector (Al thin film) with a thickness of 20 μm, and drying and roll pressing were performed to manufacture the positive electrode.

After positioning the manufactured positive electrode and the lithium metal negative electrode with a thickness of 700 μm in a dry room to face each other, a polyolefin porous separator coated with inorganic material particle AlOOH was interposed between them, and then the non-aqueous electrolyte manufactured according to the embodiment and comparative example was injected to manufacture a rechargeable battery.

After that, 1 cycle charging and discharging was performed by charging to 4.2 with constant currents of 1/3C, 1C, and 4C at 30° C. and discharging to 3.0 with constant currents of 1/3C, 1C, and 4C.

### (2) Electrodeposition Kinetics of Lithium Metal

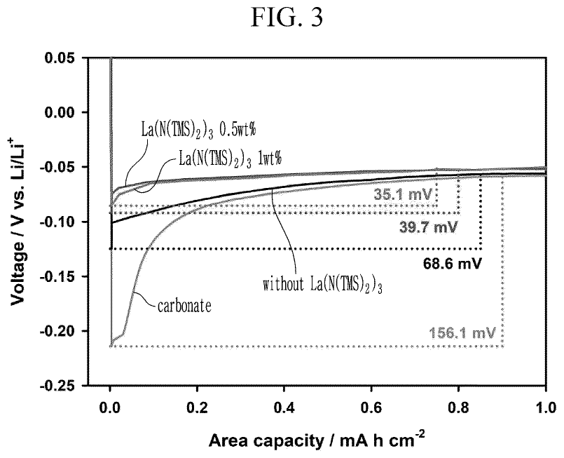

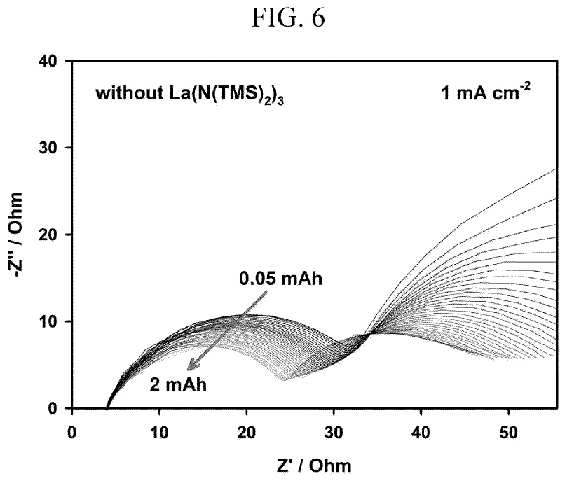

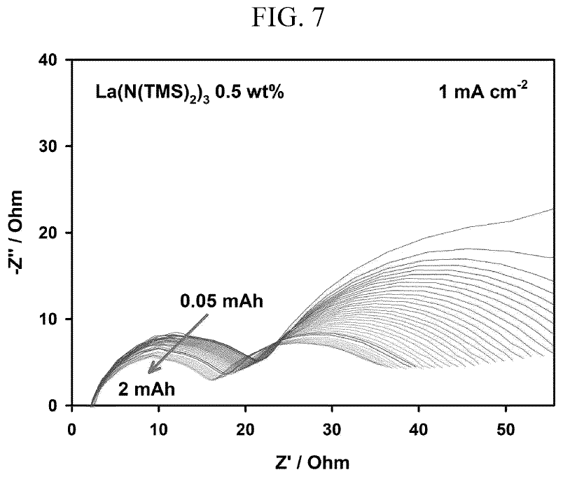

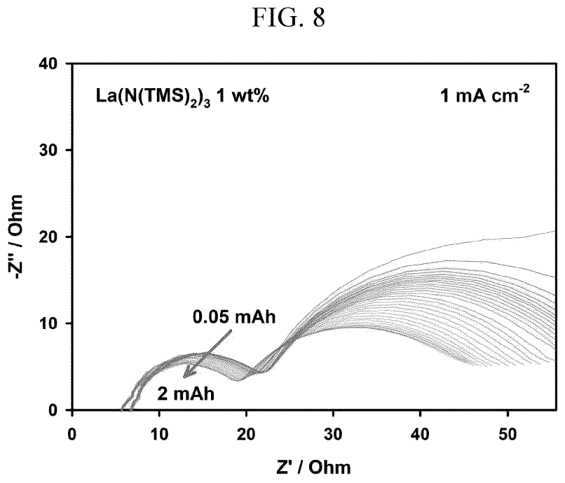

The kinetic changes in the electrodeposition of lithium metal were investigated using potentiostat (ZIVE) equipment, and the results are shown in FIGS. 3 to 5. FIGS. 6 to 8 are the results of in-situ EIS measurement while sequentially depositing lithium metal.

Referring to FIG. 3, it can be seen that when an electrolyte manufactured according to the embodiment is used, the nucleation overpotential is reduced compared to when an electrolyte manufactured according to the Comparative Example is used.

Referring to FIG. 4, it can be seen that the reversible capacity of lithium metal is increased when the electrolyte manufactured according to the embodiment is used compared to when the electrolyte manufactured according to the Comparative Example is used.

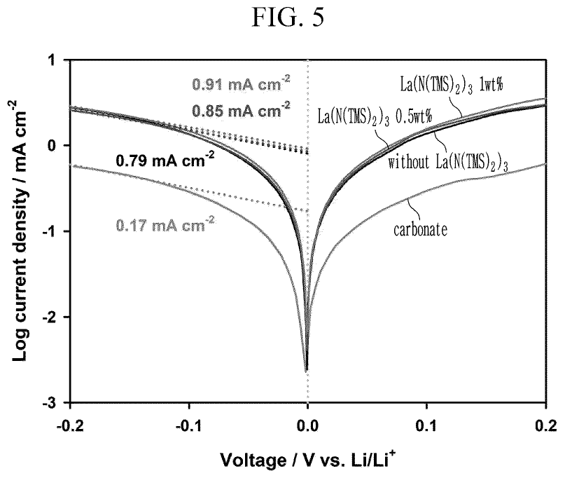

Referring to FIG. 5, it can be seen that the exchange current density increases when the electrolyte manufactured according to the embodiment is used compared to when the electrolyte manufactured according to the Comparative Example is used, so that it can be seen that the kinetics of lithium ions within the SEI layer is improved.

Referring to FIGS. 6 to 8, it can be seen that when the electrolyte manufactured according to the embodiment is used, the charge transfer resistance is smaller, and the resistance variation is also smaller compared to when the electrolyte manufactured according to the comparative example is used. It can be seen that the kinetics of lithium metal is improved, and the overvoltage and surface resistance are reduced by improving the SEI property using the electrolyte additive according to the present disclosure.

### (3) Structure Analysis of SEI Layer

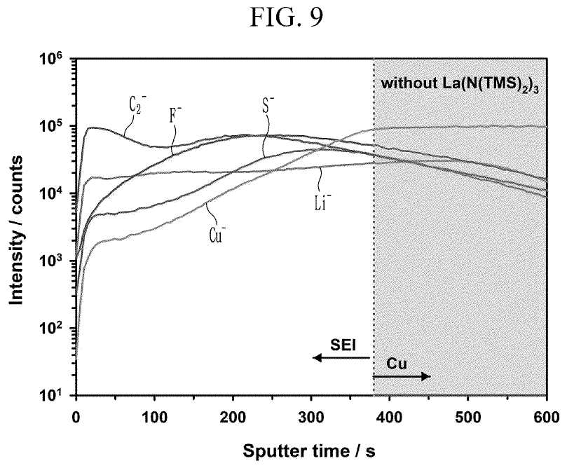

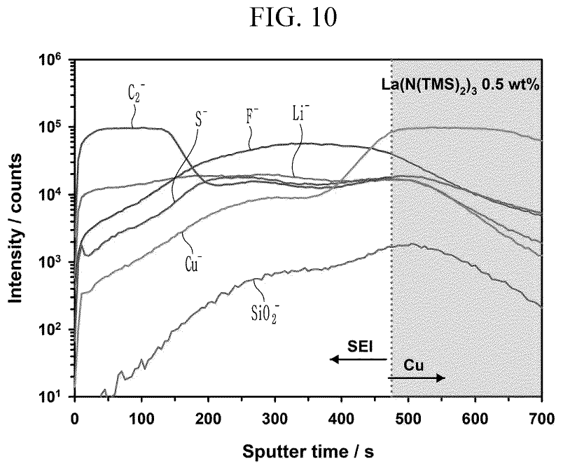

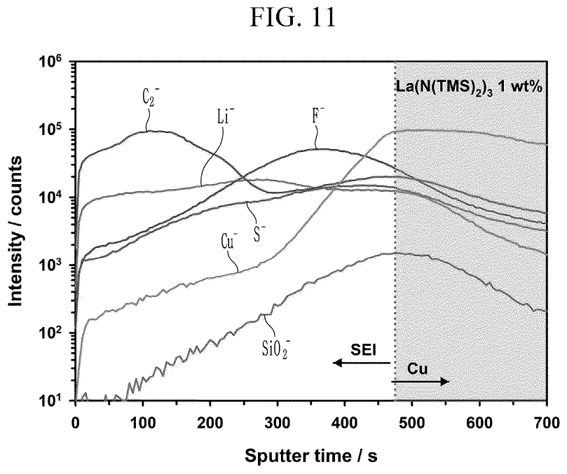

The structure analysis of the SEI layer of the lithium rechargeable battery manufactured according to Examples 1, 2 and Comparative Example 4 (without La(N(TMS)₂)₃, La(N(TMS)₂)₃ 0.5 wt %, 1 wt %) was performed using CV and ToF-SIMS, and the results are shown in FIGS. 9 to 11.

CV was measured under 0.1 mV/s condition.

Specifically, FIGS. 9 to 11 are the results of analyzing the structure according to sputter time while performing sputtering to confirm the internal SEI structure.

In the case of Comparative Example 4, it has the form of an SEI layer where inorganic material and organic material are mixed (see FIG. 2), but in the case of embodiment, it can be seen that it has the form of an SEI layer of a layered structure with an inorganic layer under an organic layer (see FIG. 1).

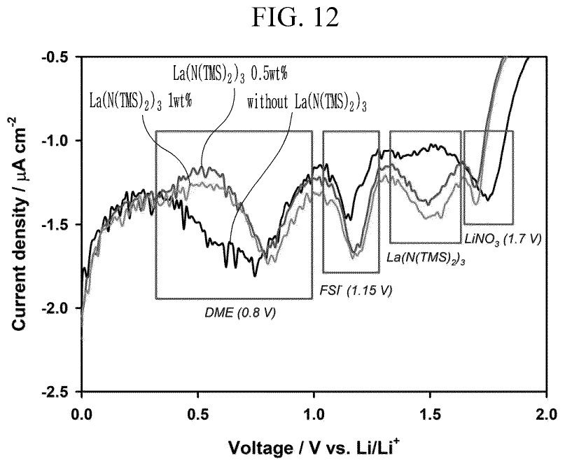

The image that identifies the order of the decomposition products using CV is shown in FIG. 12.

### (4) Surface Observation of SEI Layers

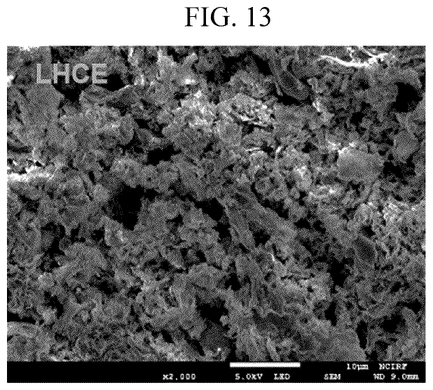

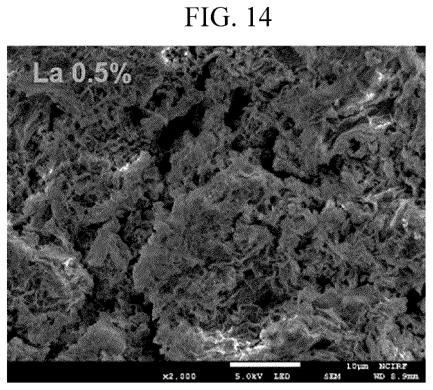

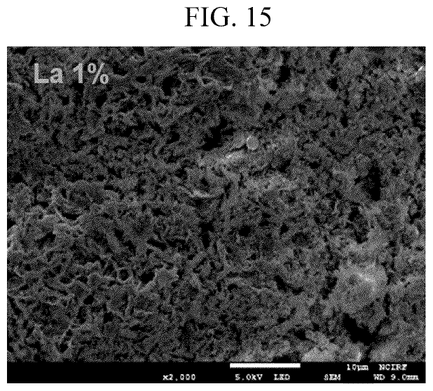

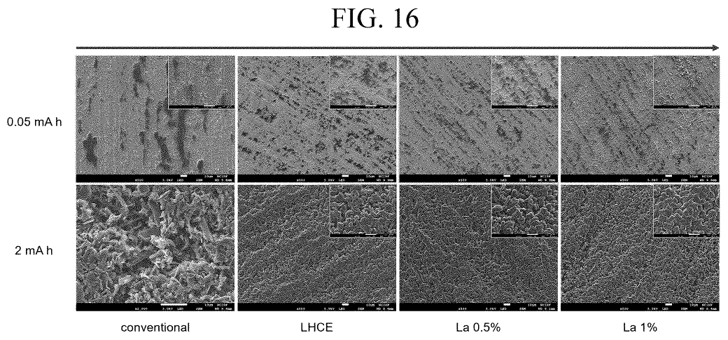

The morphology of the cycled lithium and the electrodeposited lithium was observed through SEM images, and the results are shown in FIGS. 13 to 16. The cycled lithium at this time is the morphology result after 20 cycles under 1 mA, 1 mAh condition (FIGS. 13 to 15), and the electrodeposited lithium has the morphology result of (1 mA, 0.05 mAh)/(1 mA, 2 mAh) (FIG. 16).

Referring to FIG. 16, it can be seen that the surface of the SEI layer manufactured according to the embodiment is smoother than the surface of the SEI layer manufactured according to the Comparative Example, so that it can be confirmed that the modification of the SEI layer due to the electrolyte additive according to the present disclosure has an effect on the lithium electrodeposition shape.

### (5) High-Rate Characteristics

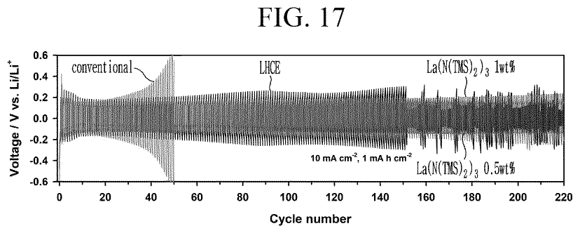

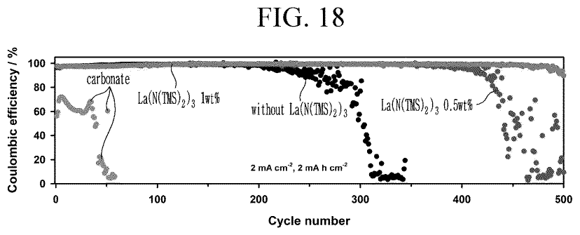

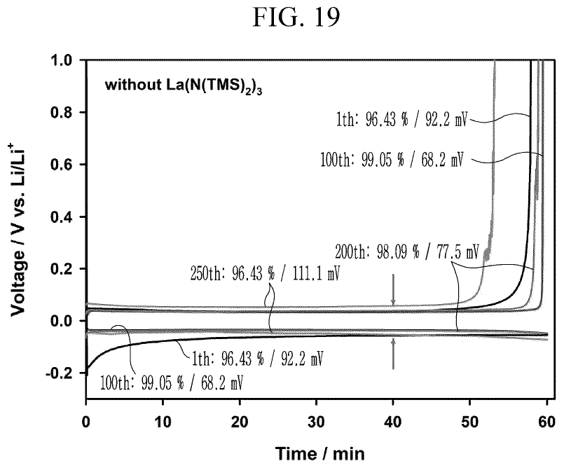

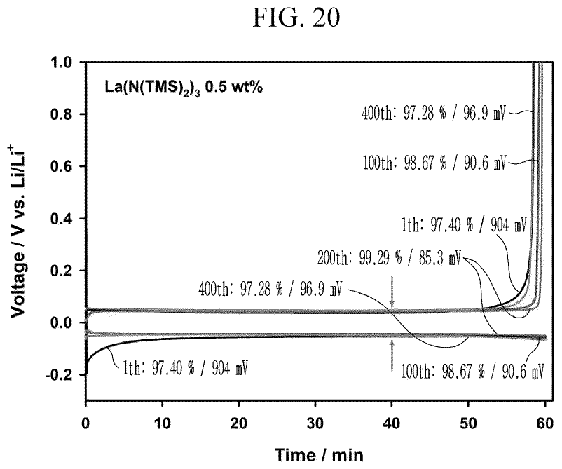

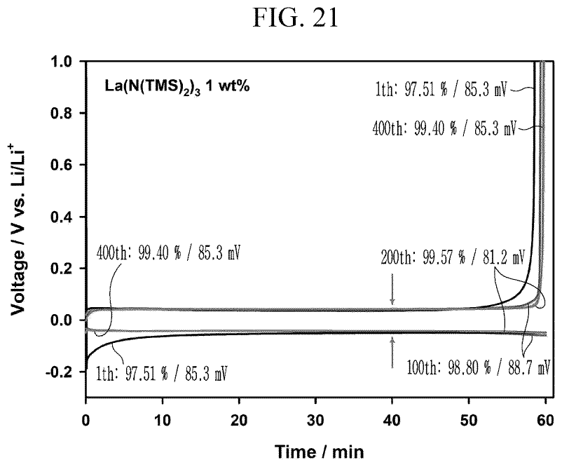

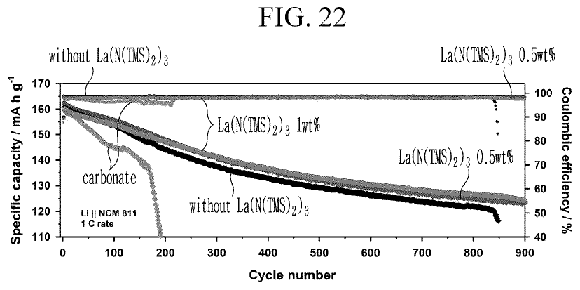

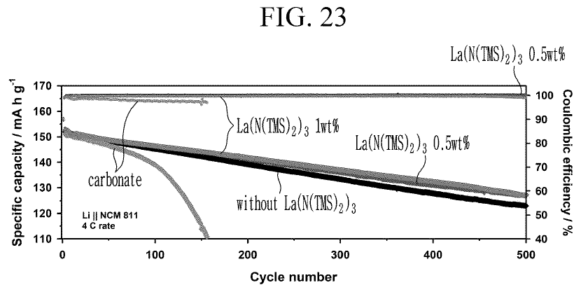

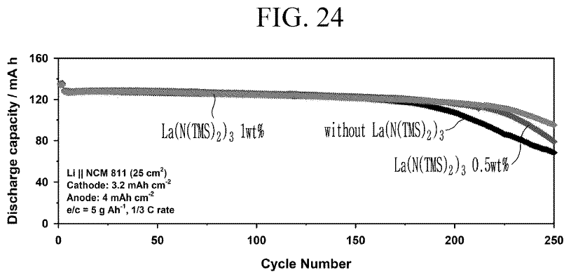

Voltage/V vs. Li/Li⁺ according to the cycle was measured (the voltage was measured using the redox potential reference of lithium) and the results are shown in FIG. 17. Additionally, the coulombic efficiency (%) according to the cycle was measured and the results are shown in FIG. 18. And Voltage/V vs. Li/Li⁺ over time were measured and the results are shown in FIGS. 19 to 21. Additionally, the specific capacity and discharge capacity results according to the cycle are shown in FIGS. 22 to 24.

Referring to FIG. 17, it can be seen that the high-rate characteristics of lithium metal are increased through SEI modification when an additive according to the present disclosure is included.

Referring to FIGS. 18 to 21, it can be seen that the reversibility of lithium metal is also improved.

Referring to FIGS. 22 to 24, it can be seen that full-cell performance is also improved when additives are present.

(6) Verification of Si—C bonding

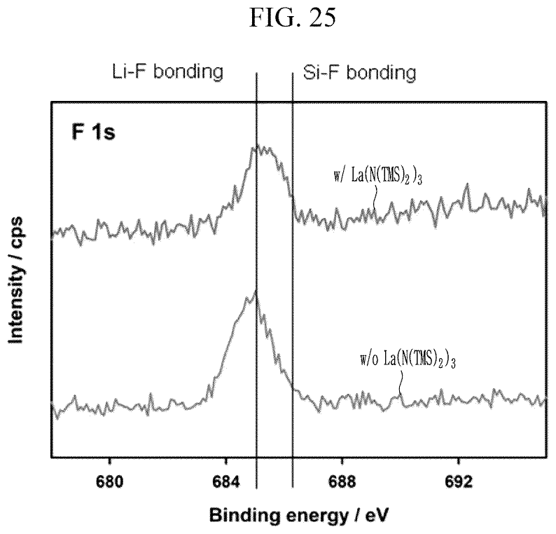

In order to confirm Si—C bonding and Si—C—O bonding (SiOC₃/SiO₂C₂) within the SEI layer, the intensity according to binding energy was measured, and the results are shown in FIG. 25.

Referring to FIG. 25, it can be seen that a Si—F shoulder peak is observed next to the Li—F bonding. From this, it can be seen that Si—C bond and Si—F bond are formed when the electrolyte additive according to the present disclosure is present, so that it can be seen that a Si-based SEI layer is formed on the lithium metal layer.

### (7) Structure of Electrolyte Additive

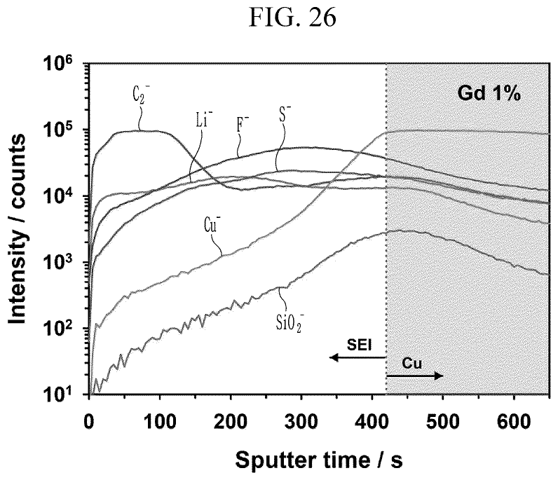

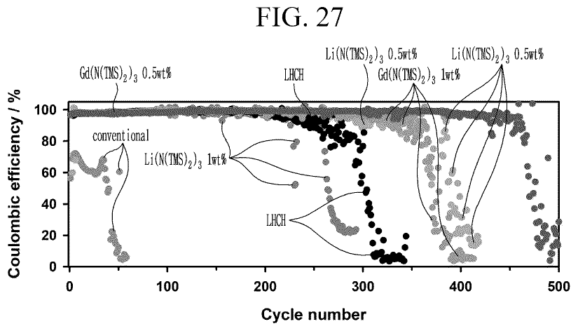

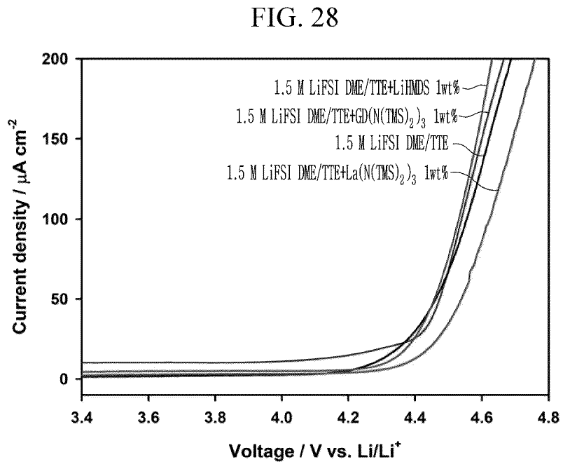

In order to confirm the internal SEI structure according to the type of metal positive ion of the electrolyte additive, the results of analyzing the structure according to sputter time while performing sputtering are shown in FIGS. 26 to 29.

Each measuring method was measured under the same conditions as the method described above.

Referring to FIGS. 26 to 29, it can be seen that a multi-layer SEI is formed even when the types of metal positive ions are different, and the reversibility of lithium metal is improved compared to a cell without additives.

In addition, it can be seen that the oxidative stability is improved when the electrolyte additive according to the present disclosure is present even when using the LHCE electrolyte of the DME/TTE series.

The present disclosure is not limited to the embodiments, but can be manufactured in various different forms, and a person of ordinary skill in the technical field to which the present disclosure belongs will be able to understand that the present disclosure can be implemented in other specific forms without changing the technical idea or essential features of the present disclosure. Therefore, the embodiments described above should be understood as exemplary in all respects and not restrictive.

What is claimed is:

1. A lithium metal negative electrode, comprising:
a lithium metal layer positioned on a current collector surface; and
an SEI layer positioned on a surface of the lithium metal layer,
wherein the SEI layer comprises an inorganic layer and an organic layer.

2. The lithium metal negative electrode of claim 1, wherein:
the inorganic layer is positioned closer to the lithium metal layer than the organic layer.

3. The lithium metal negative electrode of claim 1, wherein:
the inorganic layer comprises at least one selected from the group consisting of a compound having a Li—F bond and a compound having a Si—F bond.

4. The lithium metal negative electrode of claim 1, wherein:
the organic layer comprises a compound comprising a formula CₓO_{y}.

5. The lithium metal negative electrode of claim 1, wherein:
the organic layer comprises a compound having a Si—C bond.

6. An electrolyte additive is represented by the following formula 1: 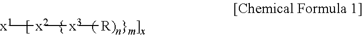
In formula 1 above,
X¹ is a metal positive ion,
each X² is independently N, P or B,
X³ is independently Si,
each R is an independently substituted or unsubstituted alkyl group of C1 to C6,
n is an integer from 1 to 3,
m is an integer from 1 to 3,
x is an integer from 1 to 3,
however, at least 3 of —X³—R are trimethylsilyl.

7. The electrolyte additive of claim 6, wherein:
the electrolyte additive is represented by the following formula 2: 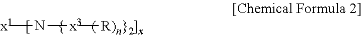
In Chemical Formula 2,
X¹, X³, n and x are defined as in formula 1 above.

8. The electrolyte additive of claim 7, wherein:
X³ is Si,
R is a methyl group.

9. The electrolyte additive of claim 8, wherein:
X¹ is La.

10. An electrolyte comprising an electrolyte additive represented by the following formula 1 and an ether electrolyte: 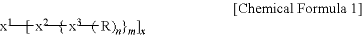
In formula 1 above,
X¹ is a metal positive ion,
each X² is independently N, P or B,
X³ is independently Si,
each R is an independently substituted or unsubstituted alkyl group of C1 to C6,
n is an integer from 1 to 3,
m is an integer from 1 to 3,
x is an integer from 1 to 3,
however, at least 3 of —X³—R are trimethylsilyl.

11. The electrolyte of claim 10, wherein:
the electrolyte additive is included at about 0.1 to 50 parts by weight relative to the entire 100 parts by weight of the electrolyte.

12. The electrolyte of claim 10, wherein:
the ether electrolyte is included at about 50 to 99.9 parts by weight for the entire 100 parts by weight of the electrolyte.

13. The electrolyte of claim 10, wherein:
the ether electrolyte comprises one or more selected from the group consisting of acyclic ethers and cyclic ethers.

14. A lithium secondary battery, comprising:
a) an electrolyte comprising an electrolyte additive of claim 6;
b) a positive electrode including a positive electrode active material; and
c) a negative electrode including:
i) a current collector, and
ii) a lithium metal layer positioned on the current collector surface, the lithium metal layer having, on its surface, a solid-electrolyte interphase (SEI) layer that comprises an inorganic layer and an organic layer, wherein the inorganic layer is positioned closer to the lithium metal layer than the organic layer, and wherein the inorganic layer comprises at least one compound having a Li—F bond and a Si—F bond.

15. The lithium secondary battery of claim 14, wherein the organic layer of the SEI comprises a carbon- and oxygen-containing structure denoted CxOy, and the inorganic layer and organic layer together form a layered SEI that improves uniformity of local current density at the lithium metal surface during charge-discharge cycling.

16. The lithium secondary battery of claim 14, wherein:
the organic layer of the SEI comprises Si—C generated from the electrolyte additive.

17. The lithium secondary battery of claim 14, wherein the electrolyte additive is represented by the following Formula 2: 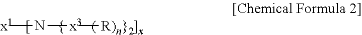
In Chemical Formula 2,
X¹, X³, n and x are defined as in formula 1 above.

18. The lithium secondary battery of claim 14, wherein:
the electrolyte further comprises an ether-based solvent mixture including one or more selected from the group consisting of acyclic ethers and cyclic ethers, and
the electrolyte additive is present in an amount of about 0.1 to about 50 parts by weight per 100 parts by weight of the electrolyte.

19. The lithium secondary battery of claim 14, wherein:
the electrolyte comprises LiFSI as a lithium salt in a concentration of about 0.5 M to about 4.0 M,
the electrolyte additive is Tris[N,N-bis(trimethylsilyl)amide]lanthanum(III), and the lithium metal negative electrode exhibits high coulombic efficiency and reduced overvoltage at current densities above 1 mA/cm².

20. The lithium secondary battery of claim 14, wherein the SEI is adapted to reduce formation of lithium dendrites and maintain reversible capacity after repeated cycling, such that the battery retains at least 80% of its initial discharge capacity after 100 charge-discharge cycles at a rate of 1C or higher.
